(19) United States
(12) Patent Application Publication
(10) Pub. No.: US 2007/0143244 A1
(43) Pub. Date: Jun. 21, 2007

(54) DATABASE SYSTEM

(76) Inventors: Pekka Kostamaa, Santa Monica, CA (US); Bhashyam Ramesh, Secunderabad (IN)

Correspondence Address: JAMES M. STOVER;NCR CORPORATION, 1700 SOUTH PATTERSON BLVD, WHQ4, DAYTON, OH, 45479, US

(21) Appl. No.: 11/608,362

(22) Filed: Dec. 8, 2006

Related U.S. Application Data
(60) Provisional application No. 60/751,611, filed on Dec. 19, 2005.
(60) Provisional application No. 60/751,612, filed on Dec. 19, 2005.

(51) Int. Cl. G06F 17/30

(52) U.S. Cl. 707/1

(57) ABSTRACT

There is provided a database system 1 including a source cluster, in the form of a source clique 2, for providing a clique shared spool file 3. This spool file is provided for consumption by a target module 4 belonging to a target cluster, in the form of a target clique 5. A node interconnect 6 receives of spool 3, and exports the spool for consumption by module 4.

### CROSS REFERENCE TO OTHER APPLICATIONS

This application incorporates by way of cross reference the subject matter disclosed in U.S. Patent Application Ser. No. 60/751,611, filed on Dec. 19, 2005, entitled A DATABASE SYSTEM, by Pekka Kostamaa and Bhashyam Ramesh, NCR Docket No. 11792.

### FIELD OF THE INVENTION

The present invention relates to a database system. The invention has been primarily developed for efficient production and shipping of intermediate query results in a multi-clique MPP system, and will be described by reference to that application. However, the invention is by no means restricted as such, and is generally applicable to database systems in a broader sense.

### BACKGROUND

Any discussion of the prior art throughout the specification should in no way be considered as an admission that such prior art is widely known or forms part of common general knowledge in the field.

Typically, a database system includes a storage device for maintaining table data made up of a plurality of rows. Access modules are provided for accessing the individual rows, usually with each row being assigned to one of the access modules. Each access module is initialized to access only those rows assigned to it. This may be zero, one, or more rows depending on the amount of data stored and hashing algorithms used. This assignment of rows to access modules facilitates the sharing of processing resources for efficient use of the database, and is common in systems that make use of Massively Parallel Processing (MPP) or clustered architectures. In known examples of such systems, actions such as row distribution and row duplication are relatively I/O intensive. This is compounded in multi-clique MPP systems or systems making use of multiple clusters.

Clique shared spool files are discussed in the above cross-referenced United States Patent Application. In brief, a database system typically passes intermediate results between access modules when processing a query. These intermediate results are generally maintained in the form of spool files. In one example, a row is redistributed from a source module to a target module. Typically this involves a spool file indicative of the row being provided by the source module to the target module via a node interconnect. The row is then written to disk by the target module. In systems that support clique shared spools, a different approach is possible. Where the source and target modules belong to a single clique, the source module writes the row to a shared spool file on the storage device associated with that clique. This shared spool file is accessible by any of the modules in the clique, and as such is available for consumption by—and effectively redistributed to—the target module.

The present disclosure is particularly concerned with situations where the source target modules belong to different cliques.

### SUMMARY

It is an object of the present invention to overcome or ameliorate at least one of the disadvantages of the prior art, or to provide a useful alternative.

In accordance with a first aspect of the invention, there is provided a database system including:
a source cluster for providing a cluster shared spool file for consumption by a target module belonging to a target cluster;
an interconnect for receiving the spool file and exporting the spool file for consumption by the target module.

Preferably each cluster interacts with an associated storage device. More preferably the spool file is written to the associated storage device of the target cluster. Still more preferably the spool file is written to a common disk area of the associated storage device.

The target cluster preferably includes a plurality of access modules and the spool file is accessible by any of these modules. In some cases spool file is accessed only by the target module. In other cases the plurality of modules includes a plurality of target modules, and the spool file is accessed by any of the target modules.

Preferably each cluster is defined by one or more nodes for carrying the modules, and node sharing of spools is enabled such that when a given module carried by a given node reads the spool file, one or more further modules carried by that given node share a common memory copy of the spool file.

In some embodiments the spool file is a redistribution spool file for consumption by the target module such that the row is effectively redistributed to the target module. Preferably only the target module consumes the redistribution spool file. In other embodiments the spool file is a duplication spool file for consumption by the target module such that the row is effectively duplicated to the target module. Typically there is a plurality of target modules and the cluster shared spool file is available for consumption by each of the target modules such that the row is duplicated to each of the target modules.

Preferably each cluster is a clique.

Preferably the system includes a plurality of source clusters, the source clusters being synchronized such that they each provide their respective spool file substantially simultaneously.

Preferably a shipping module reads the spool file from a source storage device and/or writes the spool file to the interconnect and a recipient module reads the spool file from the interconnect and/or writes the spool file to a target storage device. In some cases the shipping module is a source module. Some cases the recipient module is the target module.

According to a further aspect of the invention, there is provided a method for managing shared cluster-shared spool files in a multi-cluster database system, the method including the steps of:
receiving the spool file from a source cluster; and
providing the spool file for consumption by a target access module of a target cluster.

The terms “redistribution” and “duplication” should be read broadly for the purposes of this disclosure to include notions of “effective” or “functional” redistribution or duplication. That is, there is not direct need for a row to be physically redistributed or duplicated, only that the row be dealt with in such a matter to provide effective redistribution or duplication.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 is a schematic representation of a database system according to an embodiment of the invention;

FIG. 2 is a schematic representation of a database system according to a further embodiment of the invention;

FIG. 3 is a schematic representation of a database system according to a further embodiment of the invention;

FIG. 4 is a schematic representation of a database system according to a further embodiment of the invention;

FIG. 5 is a is a further schematic representation of the database system of FIG. 4; and

FIG. 6 is a schematic representation of a database system according to a further embodiment of the invention.

### DETAILED DESCRIPTION

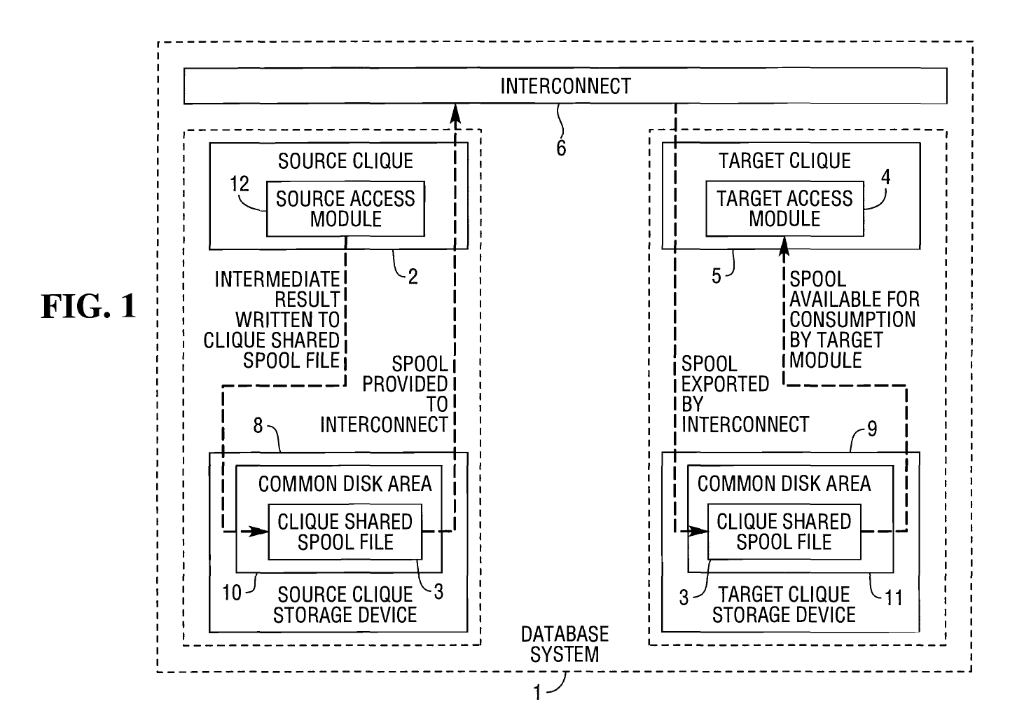

FIG. 1 illustrates a database system 1 including a source cluster, in the form of a source clique 2, for providing a clique shared spool file 3. This spool file is provided for consumption by a target module 4 belonging to a target cluster, in the form of a target clique 5. A node interconnect 6 receives of spool 3, and exports the spool for consumption by module 4.

Cliques 2 and 5 interact with respective storage devices 8 and 9. In the present embodiment, exporting spool 3 for consumption by module 4 involves writing the spool to storage device 9. As shown in latter Figures, each clique 2 and 5 includes a plurality of nodes 7, each node carrying a respective plurality of access modules such as module 4. All nodes of a given clique are cross-connected such that their carried modules are enabled to access the respective storage location 8 and 9 with which the relevant clique 2 and 5 interacts.

Although the present disclosure deals specifically with clusters in the form of cliques, it will be appreciated that the invention is applicable to clusters in a broader sense. Those skilled in the art will understand a clique to be a set of processing nodes that have access to shared I/O devices. A cluster is typically similar to a clique, although a cluster generally does not provide multiple paths to the storage device.

Although FIG. 1 shows only two cliques, it is appreciated that system 1 includes further cliques that are not shown. Additionally, in some embodiments there is a plurality of target cliques. Those skilled in the art will recognize how the illustrated embodiment is extended along such lines.

Each storage device 8 and 9 includes a respective Common Disk Area (CDA) 10 and 11, typically functionally defined by a portion of the relevant storage device that maintains a spool 3. In a simple example, a source module 12 writes a row to spool 3 on CDA 10. This spool is pre-designated for consumption by module 4 of clique 5, for instance to effect redistribution of a row. Once the row is written to spool 3, spool 3 is shipped from CDA 10 to CDA 11 via interconnect 6. Once on CDA 11 the row is available for consumption by module 4, and is effectively redistributed. It will be appreciated that the example of redistribution is not to be taken as limiting, and other processes such as duplication are also considered.

In a definitional sense, a source module is a module that writes to spool 3, and a target module is a module that consumes spool 3. It is common to have a plurality of source and target modules for a given spool 3. For example, where a row is to be redistributed from a single source module to a plurality of target modules, or in the case of duplication. In situations where a source clique includes one or more of the target modules, those modules preferably consume spool 3 in the manner disclosed in the above cross-referenced application.

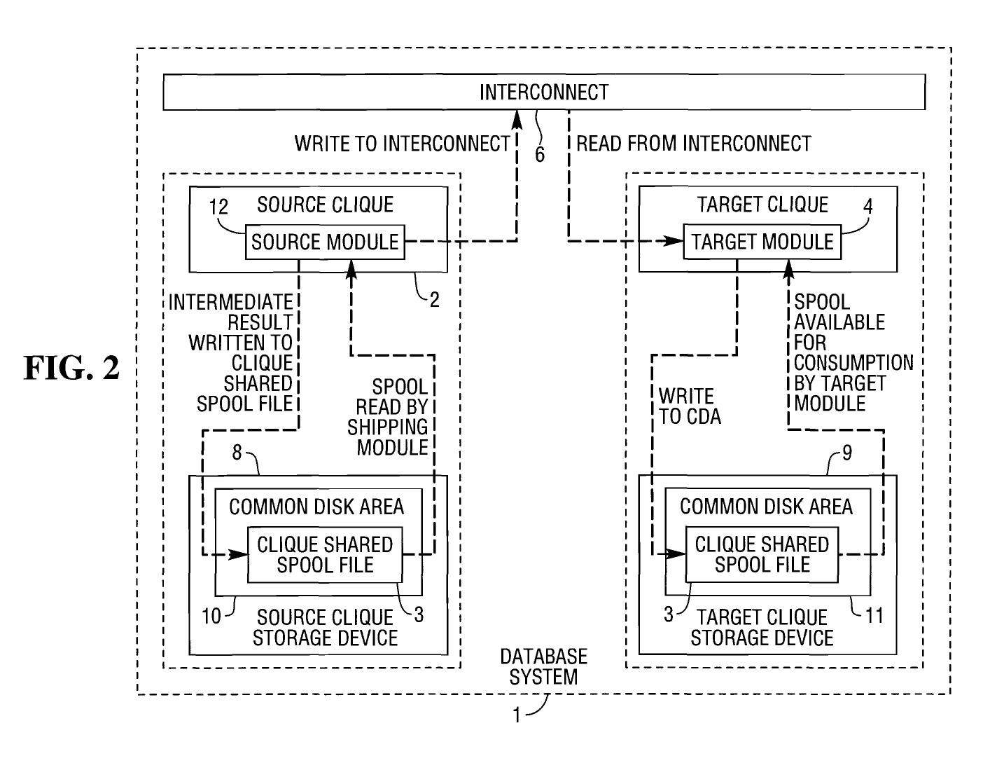

The precise mode of shipping varies between embodiments. In the embodiment of FIG. 2, module 12 reads spool 3 from CDA 10 and writes it to interconnect 6. Module 4 then reads the spool from interconnect 6, and writes it to CDA 11.

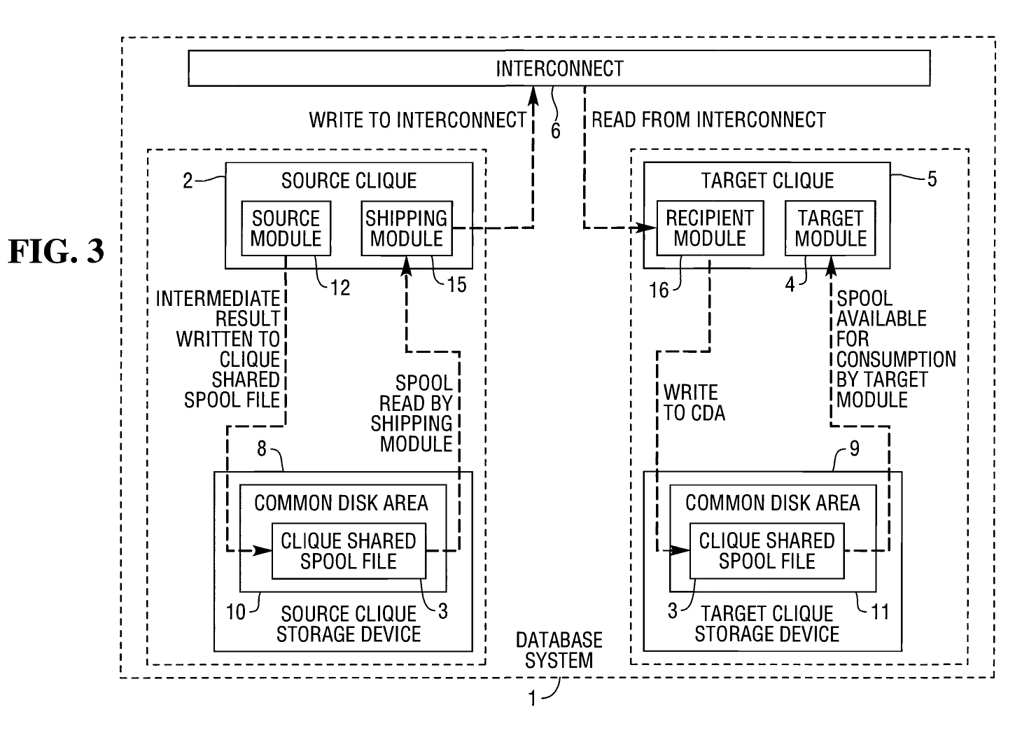

It will be appreciated that it is not entirely necessary for modules 12 and 4 to carry out the reading and writing of spool 3 and data 6. To this end, shipping modules 15 and recipient modules 16 are considered, as shown in FIG. 3. Although FIG. 3 shows the shipping and recipient modules 15 and 16 as being carried by different nodes 7 from the source and target modules 12 and 4, this is not always the case. In some embodiments they are carried by the name nodes. In other embodiments they are indeed the same module—such as in FIG. 2. In this regard, shipping and recipient modules 15 and 16 are typically only functionally defined.

The notion of shipping and recipient modules is particularly helpful when considering situations where there is a plurality of source and/or target modules for a given spool 3. This spool need only be read once from CDA 10, written to interconnect 6 once from clique 2, read once from interconnect 6 at clique 5, and written once to CDA 11. As such, for a given spool 3, there is only one shipping module for each shipped spool, and one recipient module for each target clique. This is particularly distinguished from prior art systems, which are typically far more I/O intensive in this regard.

In some embodiments, shipping and receiving modules are dynamically selected based on the level of activity of available modules. Those skilled in the art will recognize how access modules are managed in this regard.

In other embodiments alternate components are provided to facilitate the shipping of spool 3 from CDA 10 to CDA 11. In some cases particular modules are set aside for the specific purpose of shipping and receiving.

There are two primary purposes for which spool 3 is used, these being row redistribution and row duplication. Some disclosure is provided below in relation to specific techniques employed by database 1 for these purposes.

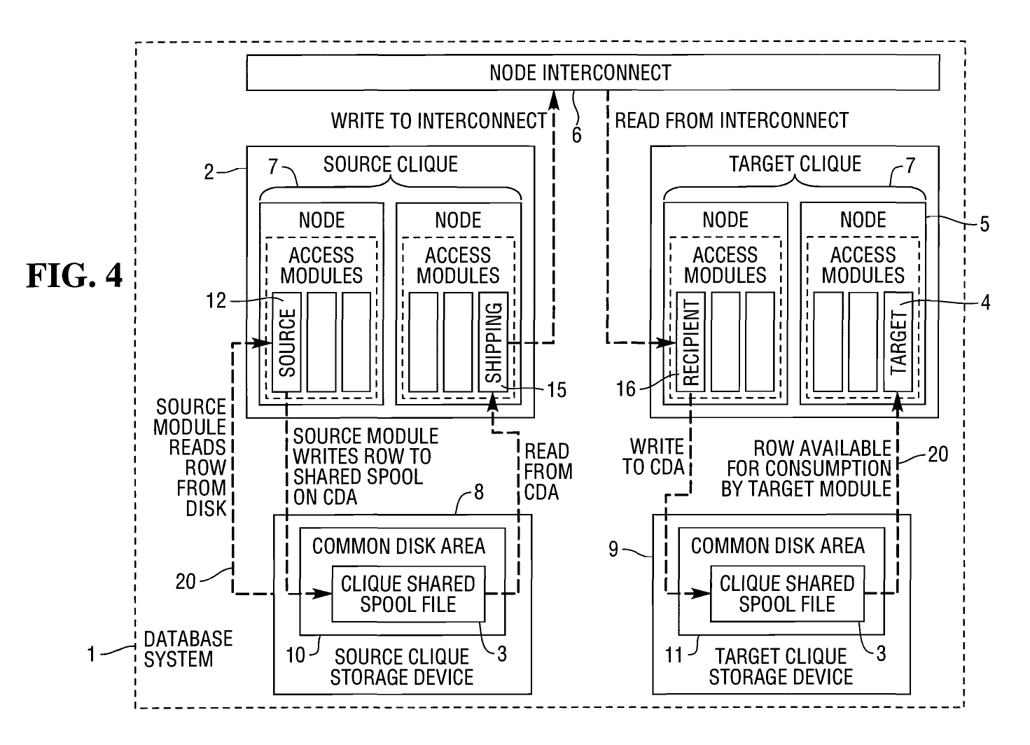

In the case of row redistribution, a clique shared spool 3 is produced on CDA 10 for each target module. This is illustrated in FIG. 4, by reference to a row 20 designated for redistribution to a target module 4. Row 20 is assigned to be accessed by source module 12. Module 12 reads row 20 from storage device 8, and writes spool 3 to CDA 10, spool 3 being indicative of row 20. Shipping module 15 (which, in some cases, is the same module as source module 12) reads spool 3 from CDA 10, and writes spool 3 to interconnect 6. Receiving module 16 (which, in some cases is target module 4) reads spool 3 from interconnect 6, and writes spool 3 to CDA 11. As such, spool 3 is available for consumption by module 4, and row 20 is effectively redistributed to that module.

In another embodiment, spool 3 is not actually written to CDA 10 in the first instance, and is written directly to interconnect 6 by module 12.

In the present embodiment, for row redistribution, one spool 3 is provided for each target module. That is, where two rows are to be redistributed to a single target module, one spool is provided (and this is written to by a pair of source modules, assuming the rows are assigned to different modules). Where a single row is to be redistributed to two target modules, two spools are provided. An underlying rationale is that only a specified target module consumes a redistribution spool file. In other embodiments, alternate approaches are considered. In other examples one spool file is provided for each node or even each clique. As such only one spool file is sent from a source node or clique to a target node or clique. It will be appreciated that such an approach reduces activity by target modules as they find their rows.

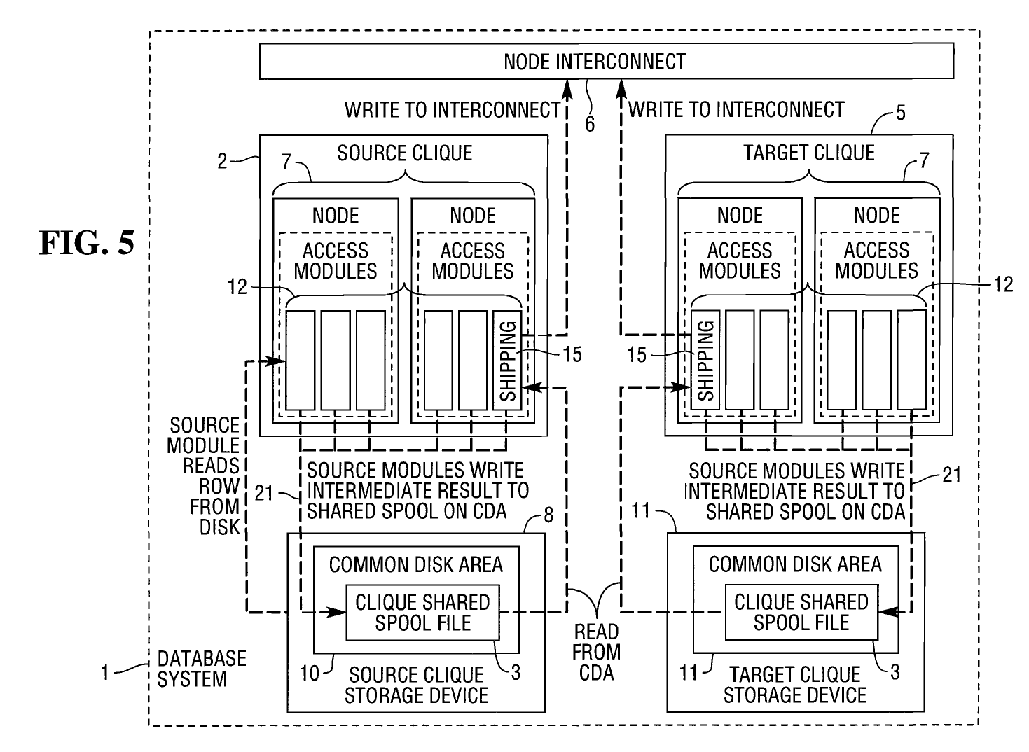

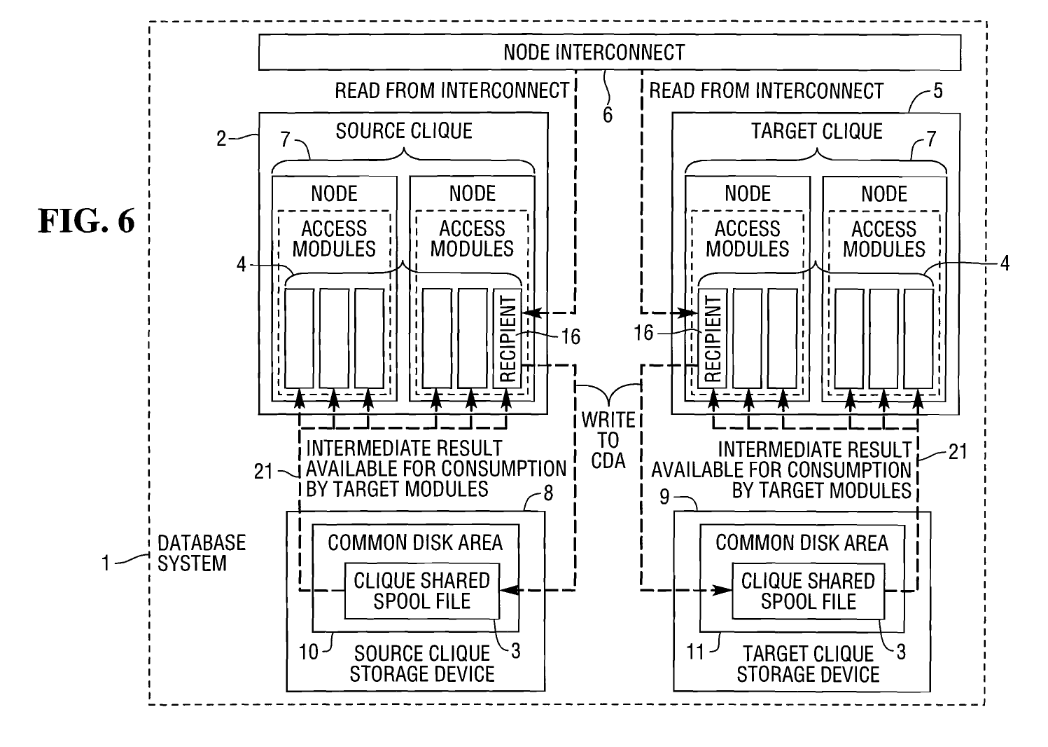

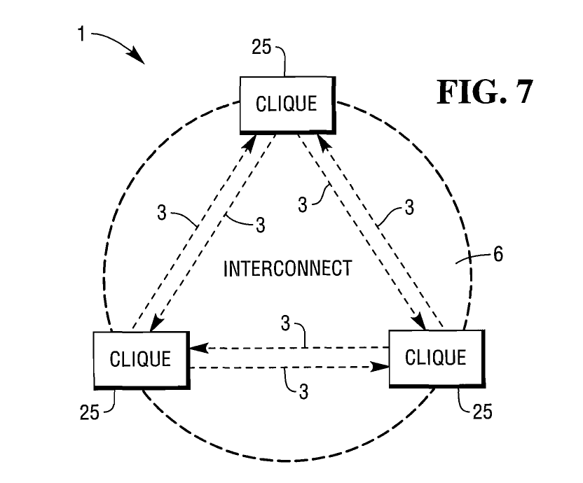

In the case of row duplication, a clique shared spool 3 is produced on CDA 10 for each duplicated intermediate result for that clique. This is illustrated in FIGS. 5 and 6, by reference to an intermediate result 21 designated for duplication. In particular, FIG. 5 shows the creation and shipping of spool 3, whilst FIG. 6 shows receipt and consumption of spool 3.

In this example, being one of duplication, both cliques 2 and 5 are functionally both source and target cliques. That is, they both produce a spool 3 for consumption by modules of the other clique. For the sake of the example, all modules are considered to be both sources 12 and targets 4.

The modules 12 of each clique write to a local spool 3 on to their accessible CDA 10 and 11. This continues until that spool 3 contains the duplicated intermediate result for the entire clique. Once the local spools 3 of each clique are fully defined, a shipping module on each of cliques 2 and 5 writes the local spool 3 to interconnect 6, and a receiving module 16 reads the incoming spool 3, and writes it to disk. Spools 3 are then available for consumption by all modules in the system, effectively duplicating the intermediate result.

FIG. 7 schematically illustrates duplication in the context of a system 1 having more than two cliques, the cliques generically designated by numeral 25. Once all cliques 25 in system 1 have produced their local duplication shared spool file 3, each clique ships via a shipping module the local spool 3 to each other clique in the system.

Interconnect 6 makes use of signaling commands to facilitate the above synchronization. For example, a module provides a signal through interconnect 6 indicative of “am I the last module to reach this synchronization point?”. If yes, then that module informs the remaining modules that synchronization is complete. This signaling functionality is in broad terms inherent to a known interconnect 6.

The above techniques will be recognized as particularly efficient from shipping perspective given that there is only one recipient module 16 for each clique for each spool. This is advantageous in that shipping is achieved in large batches, as opposed to single rows at a time.

It will be appreciated that system 1 provides considerable performance advantages as compared with known systems, particularly though significant CPU and I/O reductions. Further, system 1 is scalable to larger implementations without necessarily requiring a corresponding increase in the performance of interconnect 6.

Although the present invention has been described with particular reference to certain preferred embodiments thereof, variations and modifications of the present invention can be effected within the spirit and scope of the following claims.

What is claimed is:

1. A database system including:
a source cluster for providing a cluster shared spool file for consumption by a target module belonging to a target cluster;
an interconnect for receiving the spool file and exporting the spool file for consumption by the target module.

2. A system according to claim 1 wherein each cluster interacts with an associated storage device.

3. A system according to claim 2 wherein the spool file is written to the associated storage device of the target cluster.

4. A system according to claim 3 wherein the spool file is written to a common disk area of the associated storage device.

5. A system according to claim 3 wherein the target cluster includes a plurality of access modules and the spool file is accessible by any of these modules.

6. A system according to claim 4 wherein the spool file is accessed only by the target module.

7. A system according to claim 6 wherein the plurality of modules includes a plurality of target modules.

8. A system according to claim 7 wherein each cluster is defined by one or more nodes for carrying the modules, and node sharing of spools is enabled such that when a given module carried by a given node reads the spool file, one or more further modules carried by that given node share a common memory copy of the spool file.

9. A system according to claim 1 wherein the spool file is a redistribution spool file for consumption by the target module such that the row is effectively redistributed to the target module.

10. A system according to claim 9 wherein only the target module consumes the redistribution spool file.

11. A system according to claim 1 wherein the spool file is a duplication spool file for consumption by the target module such that the row is effectively duplicated to the target module.

12. A system according to claim 11 wherein there is a plurality of target modules and the cluster shared spool file is available for consumption by each of the target modules such that the row is duplicated to each of the target modules.

13. A system according to claim 1 wherein each cluster is a clique.

14. A system according to claim 1 including a plurality of source clusters, the source clusters being synchronized such that they each provide their respective spool file substantially simultaneously.

15. A system according to claim 1 wherein a shipping module reads the spool file from a source storage device and/or writes the spool file to the interconnect and a recipient module reads the spool file from the interconnect and writes the spool file to a target storage device.

16. A system according to claim 15 wherein the shipping module is a source module.

17. A system according to claim 15 wherein the recipient module is the target module.

18. A method for managing shared cluster-shared spool files in a multi-cluster database system, the method including the steps of:
receiving the spool file from a source cluster; and
providing the spool file for consumption by a target access module of a target cluster.
